(19) United States
(12) Patent Application Publication
(10) Pub. No.: US 2026/0341757 A1
(43) Pub. Date: Oct. 29, 2026

(54) FUEL CELL SYSTEM

(71) Applicant: Honda Motor Co., Ltd., Tokyo (JP)

(72) Inventor: Taishi Yamaguchi, Saitama (JP)

(21) Appl. No.: 19/544,978

(22) Filed: Feb. 19, 2026

(30) Foreign Application Priority Data
Feb. 28, 2025 (JP) 2025-030944

(51) Int. Cl. H01M 8/04537; H01M 8/0438; H01M 8/04746

(52) U.S. Cl. CPC H01M 8/04582; H01M 8/04388; H01M 8/04753; H01M 8/04761; H01M 8/04776

(57) ABSTRACT

A fuel cell system including a microprocessor setting an anode target pressure and a cathode target pressure in accordance with a generated current detected by a current detection part, and controlling an anode gas supply part and a cathode gas supply part in accordance with the anode target pressure and the cathode target pressure. The microprocessor is configured to perform the setting including setting the anode target pressure such that, when a predetermined decrease in the generated current is detected by the current detection part, the anode target pressure is decreased at a first rate, and subsequently decreased at a second rate having a decrease rate smaller than the first rate.

### CROSS-REFERENCE TO RELATED APPLICATION

This application is based upon and claims the benefit of priority from Japanese Patent Application No. 2025-030944 filed on Feb. 28, 2025, the content of which is incorporated herein by reference.

### BACKGROUND OF THE INVENTION

### Field of the Invention

This invention relates to a fuel cell system including a humidifier.

### Description of the Related Art

In recent years, technological developments have been made on a fuel cell that contribute to energy efficiency to ensure access to energy that is affordable, reliable, sustainable and advanced by more people. As a technology related to this type of fuel cell, a fuel cell system equipped with a discharge valve that discharges fuel gas and a circulation pump that circulates the fuel gas is known. Such a system is described, for example, in Japanese Examined Patent Publication No. 4561048 (JP 4561048 B). The system described in JP 4561048 B stops the supply of fuel gas to the injector and activates the circulation pump to circulate the fuel gas when the operating load decreases sharply from high load to medium load, etc.

However, as with the fuel cell system described in JP 4561048 B, if the supply of fuel gas to the injector is stopped when the operating load decreases sharply, the fuel gas flow path may become filled with produced water, leading to a decrease in power generation performance.

### SUMMARY OF THE INVENTION

An aspect of the present invention is a fuel cell system including: a current detection part configured to detect a generated current of a fuel cell generating power through a supply of an anode gas and a cathode gas; an anode gas supply part configured to supply the anode gas to the fuel cell through an anode supply flow path; a cathode gas supply part configured to supply the cathode gas to the fuel cell through a cathode supply flow path; a gas circulation part circulating the anode gas discharged from the fuel cell to the anode supply flow path; and an electronic control unit including a microprocessor and a memory connected to the microprocessor. The microprocessor is configured to perform setting an anode target pressure as a target pressure of the anode gas and a cathode target pressure as a target pressure of the cathode gas, in accordance with the generated current detected by the current detection part, and controlling the anode gas supply part and the cathode gas supply part in accordance with the anode target pressure and the cathode target pressure, the setting including setting the anode target pressure such that, when a predetermined decrease in the generated current is detected by the current detection part, the anode target pressure is decreased at a first rate, and subsequently decreased at a second rate having a decrease rate smaller than the first rate.

### BRIEF DESCRIPTION OF THE DRAWINGS

The objects, features, and advantages of the present invention will become clearer from the following description of embodiments in relation to the attached drawings, in which:

FIG. 1 is a diagram illustrating a schematic configuration of a fuel cell system according to an embodiment of the present invention;

FIG. 2 is a cross-sectional view of a main part of a fuel cell stack included in the fuel cell system in FIG. 1;

FIG. 3 is a block diagram illustrating a control configuration of the fuel cell system according to the embodiment of the present invention;

FIG. 4A is a time chart illustrating an example of an operation by a first reference example for the fuel cell system according to the embodiment of the present invention;

FIG. 4B is a time chart illustrating an example of an operation by a second reference example for the fuel cell system according to the embodiment of the present invention;

FIG. 5A is a time chart illustrating an example of an operation by the fuel cell system according to the embodiment of the present invention;

FIG. 5B is an enlarged view of a part in FIG. 5A;

FIG. 6 is a time chart illustrating an example of an operation by a valve control unit in FIG. 3;

FIG. 7 is a time chart for explaining a modification of the anode control unit in FIG. 3; and

FIG. 8 is a flowchart illustrating an example of processing performed by the anode control unit in FIG. 3.

### DETAILED DESCRIPTION OF THE INVENTION

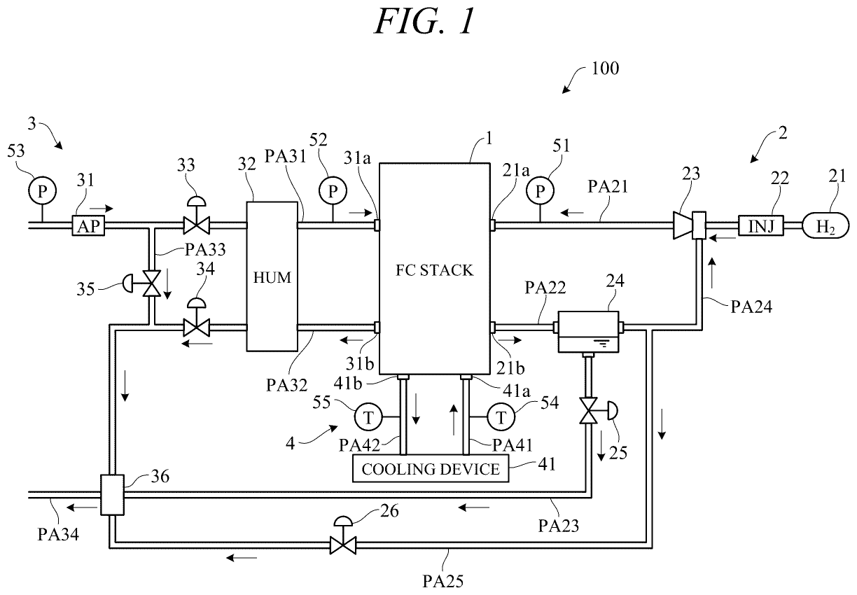

Hereinafter, an embodiment of the present invention will be described with reference to FIGS. 1 to 8. FIG. 1 is a diagram illustrating a schematic configuration of a fuel cell system 100 according to an embodiment of the present invention. The fuel cell system 100 of FIG. 1 is mounted on, for example, a vehicle (fuel cell vehicle) and generates electric power to be supplied to a traveling motor of the vehicle.

As illustrated in FIG. 1, the fuel cell system 100 includes a fuel cell stack 1, a fuel gas supply and exhaust part 2 that supplies a fuel gas (anode gas) to the fuel cell stack 1 and discharges the fuel gas from the fuel cell stack 1, an oxidant gas supply and exhaust part 3 that supplies an oxidant gas (cathode gas) to the fuel cell stack 1 and discharges the oxidant gas from the fuel cell stack 1, and a cooling medium supply and exhaust part 4 that supplies a cooling medium to the fuel cell stack 1 and discharges the cooling medium from the fuel cell stack 1. The fuel gas is, for example, hydrogen. The oxidant gas is, for example, air containing oxygen. The cooling medium is, for example, water or a coolant liquid containing ethylene glycol or propylene glycol.

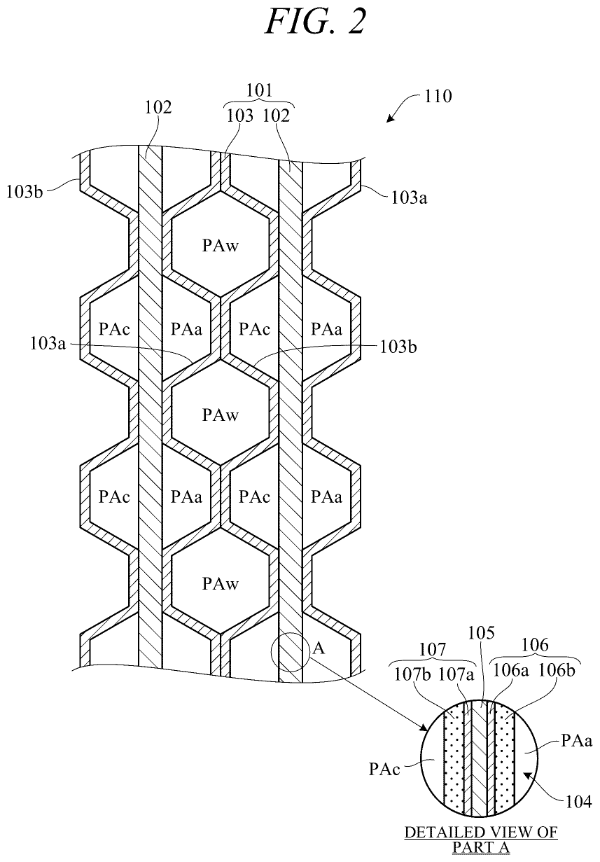

FIG. 2 is a cross-sectional view of a main part of the fuel cell stack 1. As illustrated in FIG. 2, the fuel cell stack 1 includes a cell stacked body 110 configured by stacking a plurality of power generation cells 101. The power generation cell 101 includes a unitized electrode assembly (UEA) 102 including a membrane electrode assembly (MEA) having an electrolyte membrane and electrodes, and a separator 103 alternately arranged with the unitized electrode assembly 102. The separator 103 integrally includes an anode separator 103a which is a plate member disposed facing one surface of the unitized electrode assembly 102, and a cathode separator 103b which is a plate member disposed facing the other surface of the unitized electrode assembly 102.

Inside the separator 103 enclosed by the anode separator 103a and the cathode separator 103b, a cooling flow path PAw through which a cooling medium flows is formed. The generating surface of the power generation cell 101 is cooled by the flow of the cooling medium. The surface of the separator 103 facing the unitized electrode assembly 102 is formed into an uneven shape by press molding or the like to form a gas flow path between the separator 103 and the unitized electrode assembly 102. An anode flow path PAa through which the fuel gas flows is formed in the recess between the unitized electrode assembly 102 and the anode separator 103a. A cathode flow path PAc through which the oxidant gas flows is formed in the recess between the unitized electrode assembly 102 and the cathode separator 103b.

FIG. 2 includes an enlarged cross-sectional view of the membrane electrode assembly 104 (detailed view of part “A”) as a cross-sectional view of the unitized electrode assembly 102. As illustrated in the detailed view of part “A” in FIG. 2, the membrane electrode assembly 104 has an electrolyte membrane 105, an anode electrode 106 provided on one surface of the electrolyte membrane 105, and a cathode electrode 107 provided on the other surface 232 of the electrolyte membrane 105. The electrolyte membrane 105 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 106 has an electrode catalyst layer 106a formed on one surface of the electrolyte membrane 105 and served as a reaction field for electrode reaction, and a gas diffusion layer 106b formed on the surface of the electrode catalyst layer 106a on the opposite side of the electrolyte membrane 105 to spread and supply the fuel gas. The cathode electrode 107 has an electrode catalyst layer 107a formed on the other surface of the electrolyte membrane 105 and served as a reaction field for electrode reaction, and a gas diffusion layer 107b formed on the surface of the electrode catalyst layer 107a on the opposite side of the electrolyte membrane 105 to spread and supply the oxidant gas. Intermediate layers (underlayers) can also be provided between the electrode catalyst layer 106a and 107a and the gas diffusion layer 106b and 107b.

The electrode catalyst layers 106a and 107a include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers 106b and 107b are made of conductive members with gas permeability, such as carbon porous bodies. The gas diffusion layers 106b and 107b can retain the fuel gas and the oxidant gas.

In the anode electrode 106, the fuel gas (hydrogen) supplied through the anode flow path PAa is ionized by an action of a catalyst, passes through the electrolyte membrane 105, and moves to the cathode electrode side. Electrons generated at this time pass through an external circuit and are extracted as electric energy. In the cathode electrode 107, an oxidant gas (oxygen) supplied via the cathode flow path PAc reacts with hydrogen ions guided from the anode electrode 106 and electrons moved from the anode electrode 106 to generate water. The generated water gives an appropriate humidity to the electrolyte membrane 105, and excess water is discharged to an outside of the unitized electrode assembly 102 along the gas flow. The generated water on the cathode side also flows to the anode side by back diffusion through the electrolyte membrane 105. Therefore, both the fuel gas and oxidant gas contain generated water. Both the fuel gas and oxidant gas also contain condensed water.

As illustrated in FIG. 1, the fuel gas supply and exhaust part 2 includes a fuel gas tank 21 in which fuel gas (anode gas) is stored, a fuel gas supply flow path PA21 for guiding the fuel gas in the fuel gas tank to the fuel gas inlet 21a of the fuel cell stack 1, and a fuel gas discharge flow path PA22 through which the fuel gas (fuel exhaust gas) discharged from the fuel gas outlet 21b of the fuel cell stack 1 flows. An injector 22 and an ejector 23 are arranged in the fuel gas supply flow path PA21. A gas-liquid separator 24 is connected to the fuel gas discharge flow path PA22.

The injector 22 is configured by a single electromagnetic injector or multiple electromagnetic injectors connected in parallel. The fuel gas is injected toward the ejector 23 by the operation of the injector 22. The ejector 23 includes a nozzle section, a suction section, a merging section, and a diffuser section. The fuel gas injected from the injector 22 passes through the small-diameter nozzle section and then flows into the diffuser section via the merging section. The fuel gas that has passed through the ejector 23 is supplied to the fuel cell stack 1 via the fuel gas inlet 21a.

The fuel gas discharged from the fuel gas outlet 21b, that is, the fuel exhaust gas (anode off-gas), is separated into fuel gas and water by the gas-liquid separator 24. The water separated by the gas-liquid separator 24 is discharged to the outside via an electromagnetic drain valve 25 and a drain flow path PA23. The fuel gas separated by the gas-liquid separator 24 is guided to the circulation flow path PA24. The ejector 23 is connected to the circulation flow path PA24, and is connected to a purge valve 26 via a purge flow path PA25. The purge valve 26 is an electromagnetic valve device that can open and close, and it allows the fuel gas in the circulation flow path PA24 to be discharged the outside via the purge flow path PA25 and the purge valve 26.

In the ejector 23, the fuel gas separated by the gas-liquid separator 24 is sucked in via the circulation flow path PA24 by the flow of fuel gas injected from the injector 22. The sucked-in fuel gas merges with the fuel gas that has passed through the nozzle section of the ejector 23 at the merging section of the ejector 23, and after being made into a uniform flow in the diffuser section of the ejector 23, it is supplied to the fuel cell stack 1 via the fuel gas inlet 21a.

The oxidant gas supply and exhaust part 3 includes an electric air pump 31 that generates high-pressure oxidant gas (cathode gas), an oxidant gas supply flow path PA31 that guides the oxidant gas generated by the air pump 31 to the oxidant gas inlet 31a of the fuel cell stack 1, and an oxidant gas discharge flow path PA32 through which the oxidant gas (oxidant exhaust gas) discharged from the oxidant gas outlet 31b of the fuel cell stack 1 flows. The air pump 31 functions as a gas supply part that compresses air taken from the atmosphere to generate high-pressure oxidant gas. The air pump 31 may be configured as a compressor.

A humidifier 32 is arranged intersecting the oxidant gas supply flow path PA31 and the oxidant gas discharge flow path PA32. In the humidifier 32, a humidity exchange occurs between the oxidant gas and the oxidant exhaust gas, and the oxidant gas in the oxidant gas supply flow path PA31 is humidified by the moisture (water vapor) contained in the oxidant exhaust gas in the oxidant gas discharge flow path PA32.

The oxidant gas supply and exhaust part 3 further includes a bypass flow path PA33. The bypass flow path PA33 is connected to the oxidant gas supply flow path PA31 upstream of the humidifier 32 and the oxidant gas discharge flow path PA32 downstream of the humidifier 32. Through the bypass flow path PA33, the oxidant gas can flow bypassing the humidifier 32 and the fuel cell stack 1.

In the oxidant gas supply flow path PA31, an electromagnetic control valve 33 with adjustable opening is provided between the bypass flow path PA33 and the humidifier 32. In the oxidant gas discharge flow path PA32, an electromagnetic control valve 34 with adjustable opening is provided between the bypass flow path PA33 and the humidifier 32. In the bypass flow path PA33, an electromagnetic control valve 35 with adjustable opening is provided. By controlling the air pump 31 and the control valves 33 to 35, the supply amount and pressure of the oxidant gas supplied to the fuel cell stack 1 can be adjusted. Additionally, by controlling the control valves 33 to 35, the bypass amount of the oxidant gas bypassing the fuel cell stack 1 can be adjusted.

A diluter 36 is connected to the downstream end of the oxidant gas discharge flow path PA32. The ends of the drain flow paths PA23 and purge flow path PA25 are also connected to the diluter 36. In the diluter 36, the fuel exhaust gas guided through the purge flow path PA25 is diluted with the oxidant exhaust gas. The diluted fuel exhaust gas is discharged to the outside (atmosphere) through the drain flow path PA34 along with the liquid water guided through the drain flow path PA23.

The cooling medium supply and exhaust part 4 includes a cooling device 41, a cooling medium supply flow path PA41 connecting the cooling device 41 and the cooling medium inlet 41a of the fuel cell stack 1, and a cooling medium discharge flow path PA42 connecting the cooling device 41 and the cooling medium outlet 41b of the fuel cell stack 1. Although not shown, the cooling device 41 includes a pump for pressurizing the cooling medium toward the fuel cell stack 1, a heat exchanger (radiator) for cooling the cooling medium that has been heated by passing through the fuel cell stack 1, and a cooling fan for blowing cooling air to the heat exchanger.

In the fuel gas supply flow path PA21, a pressure sensor 51 is connected downstream of the ejector 23. The pressure sensor 51 detects the inlet pressure (anode pressure Pa) of the fuel gas supplied to the fuel cell stack 1. In the oxidant gas supply flow path PA31, a pressure sensor 52 is connected downstream of the humidifier 32. The pressure sensor 52 detects the inlet pressure (cathode pressure Pc) of the oxidant gas supplied to the fuel cell stack 1. Furthermore, in the oxidant gas supply flow path PA31, a pressure sensor 53 is connected upstream of the air pump 31. The pressure sensor 53 detects the atmospheric pressure P0.

In the cooling medium supply flow path PA41, a temperature sensor 54 is connected to detect the temperature (cooling medium inlet temperature) of the cooling medium. In the cooling medium discharge flow path PA42, a temperature sensor 55 is connected to detect the temperature (cooling medium outlet temperature) of the cooling medium. The cooling medium inlet temperature and the cooling medium outlet temperature are collectively referred to as a cooling medium temperature Te. The cooling medium temperature Te refers to either or both the cooling medium inlet temperature and the cooling medium outlet temperature. The cooling medium temperature Te may be an average of the cooling medium inlet temperature and the cooling medium outlet temperature.

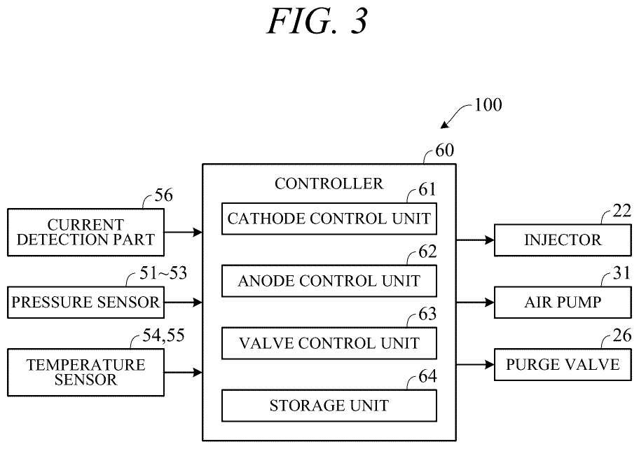

FIG. 3 is a block diagram illustrating a control configuration of the fuel cell system 100 according to the embodiment of the present invention. As illustrated in FIG. 3, the fuel cell system 100 includes a controller 60, and a current detection part 56, pressure sensors 51 to 53, temperature sensors 54 and 55, an injector 22, an air pump 31, and a purge valve 26, which are connected to the controller 60.

The current detection part 56 includes, for example, a current sensor that detects an output current of fuel cell stack 1. The fuel cell system 100 is configured to calculate a power (required power) or a power generation amount required by the vehicle (required power generation amount) and generate power corresponding to the required power or the required power generation amount. Therefore, the current detection part 56 may calculate the output current by using the required power or the required power generation amount. That is, the current detection part 56 may obtain, by calculation, the output current by using a parameter having a correlation with the output current instead of detecting the output current by a sensor. In other words, the current detection part 56 may be provided inside the controller 60. As described above, detecting the output current by the current detection part 56 includes obtaining the output current by calculation.

Signals from the output current detected by the current detection part 56, an anode pressure Pa detected by the pressure sensor 51, a cathode pressure Pc detected by the pressure sensor 52, an atmospheric pressure P0 detected by the pressure sensor 53, and a cooling medium temperature Te detected by the temperature sensors 54 and 55 are input to the controller 60. The cooling medium temperature Te has a correlation with the temperatures of fuel gas and oxidant gas. Therefore, the cooling medium temperature Te is used as a parameter representing the temperatures of the fuel gas and the oxidant gas. The controller 60 executes predetermined processing based on these input signals, and outputs control signals to the injector 22, the air pump 31, and the purge valve 26.

The controller 60 is a computer including an arithmetic processing device including a CPU, a ROM, a RAM, and other peripheral circuits. The controller 60 includes a cathode control unit 61, an anode control unit 62, a valve control unit 63, and a storage unit 64 as functional components. Various maps, thresholds, arithmetic expressions, programs, and the like are stored in the storage unit 64. The volume of the anode flow path PAa and the volume of the gas diffusion layer 106b (FIG. 2) capable of retaining fuel gas are also stored in the storage unit 64.

The controller 60 calculates the required power. More specifically, the controller 60 calculates target drive torque of the traveling motor, based on a signal from an accelerator opening sensor, which detects an opening degree of the accelerator pedal, and calculates the required power necessary for the traveling motor to generate the target drive torque. Alternatively, the controller 60 calculates the required power generation amount, based on a signal from a battery sensor, which detects a remaining capacity SOC of the battery, so that the remaining capacity of the battery has a predetermined value. The controller 60 may calculate the required power generation amount instead of the required power.

The cathode control unit 61 calculates a target flow rate of the oxidant gas corresponding to the required power, and outputs a control signal to the air pump 31 such that the oxidant gas corresponding to the target flow rate is supplied to the fuel cell stack 1. Accordingly, the cathode pressure Pc detected by the pressure sensor 52 approaches a cathode target pressure Pct corresponding to the target flow rate. In practice, the cathode control unit 61 outputs a control signal not only to the air pump 31 but also to the control valves 33 to 35 and the like, but for convenience, description of control other than the air pump is omitted.

Similarly to the cathode control unit 61, the anode control unit 62 calculates a target flow rate of the fuel gas corresponding to the required power, and outputs a control signal to the injector 22 so that the fuel gas corresponding to the target flow rate is supplied to the fuel cell stack 1. More specifically, the anode control unit 62 calculates a target injection cycle and a target injection amount (duty ratio) of the injector 22, and controls the injector 22 according to the target injection cycle and the target injection amount.

In this case, the anode control unit 62 stops the fuel injection when the anode pressure Pa is higher than the anode target pressure Pat. Then, when the anode pressure Pa becomes equal to or lower than the anode target pressure Pat, the anode control unit 62 outputs a control signal to the injector 22 to inject fuel from the injector 22. That is, the anode control unit 62 injects fuel from the injector 22 on condition that the anode pressure Pa becomes equal to or lower than the anode target pressure Pat. Accordingly, the anode pressure Pa detected by the pressure sensor 51 approaches the anode target pressure Pat.

The air supplied to the cathode flow path PAc contains nitrogen. The valve control unit 63 calculates an amount of nitrogen permeating from the cathode flow path PAc to the anode flow path PAa by using the anode pressure Pa, the cathode pressure Pc, and the cooling medium temperature Te, and calculates a nitrogen concentration in the anode flow path PAa by dividing the amount of nitrogen by the amount of fuel gas in the anode flow path PAa. Further, the valve control unit 63 multiplies the nitrogen concentration by the anode pressure Pa to calculate a nitrogen partial pressure. When the nitrogen concentration increases, the power generation performance decreases. Therefore, when the nitrogen partial pressure becomes equal to or greater than a predetermined value, the valve control unit 63 outputs a control signal to the purge valve 26 to open the purge valve 26. Accordingly, the fuel gas containing nitrogen flows out from the anode flow path PAa, and the nitrogen partial pressure can be maintained at the predetermined value or less.

In such a fuel cell system 100, for example, when a traveling vehicle rapidly decelerates, the required power rapidly decreases. At this time, the cathode pressure Pc changes with excellent responsiveness according to a change in the rotation speed of the air pump 31. Therefore, if the cathode target pressure Pct is rapidly reduced, the cathode pressure Pc can be reduced accordingly. On the other hand, since the fuel gas circulates through a circulation flow path PA24, it is difficult to rapidly decrease the anode pressure Pa. As a result, the following problems occur.

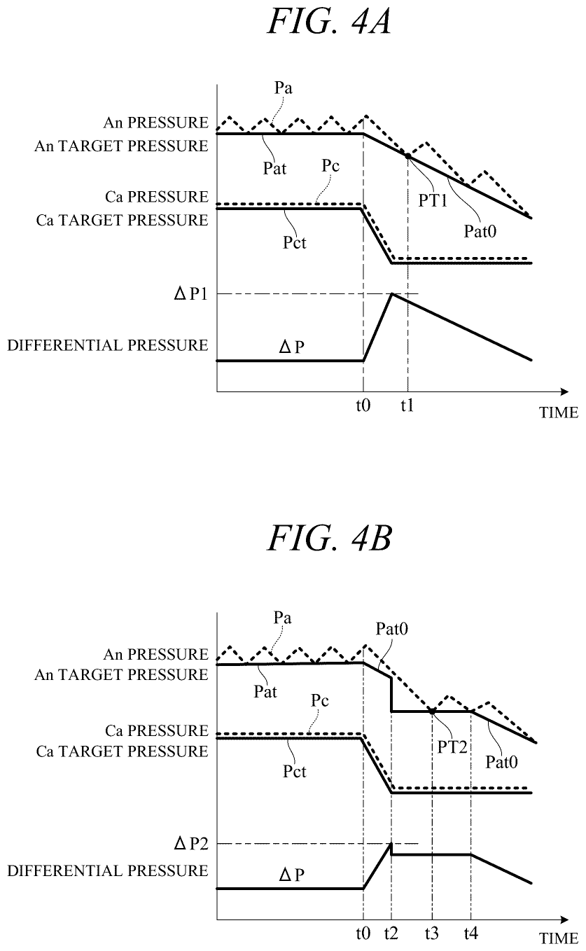

FIG. 4A is a time chart illustrating an example of changes with the lapse of time in the anode pressure Pa (dotted line) and the anode target pressure Pat (solid line), the cathode pressure Pc (dotted line) and the cathode target pressure Pct (solid line), and a differential pressure ΔP obtained by subtracting the cathode target pressure Pct from the anode target pressure Pat during deceleration of the vehicle. This time chart is a time chart as a first reference example of the present embodiment for explaining a problem during the deceleration. The fuel gas is intermittently injected from the injector 22 by duty control, but in FIG. 4A, the change in the anode pressure Pa is indicated by a triangular continuous pulse waveform for convenience. The rising point of the triangular pulse waveform corresponds to injection start time point of the fuel gas.

The required power changes according to the operation of the accelerator pedal, and the output current and the vehicle speed change accordingly. Time point t0 in FIG. 4A is a deceleration start time point at which the vehicle starts rapid deceleration. As illustrated in FIG. 4A, when the vehicle starts deceleration at time point t0, the output current decreases. At this time, the cathode target pressure Pct decreases at a decrease rate corresponding to the decrease in the output current, and the cathode pressure Pc also decreases accordingly. On the other hand, the anode target pressure Pat also decreases from the deceleration start time point, but the anode pressure Pa has poor responsiveness as described above. Therefore, the decrease rate (slope) of the anode target pressure Pat is smaller than the decrease rate (slope) of the cathode target pressure Pct.

In this case, injection start time point of the fuel gas (injection start time point immediately after deceleration) t1 of the injector 22, which is determined by an intersection PT1 of the anode target pressure Pat and the anode pressure Pa, is delayed as the decrease rate (referred to as a reference rate Pat0) of the anode target pressure Pat per unit time increases. Although generated water in the anode flow path PAa can be swept out by the injection of the fuel gas, when injection start time point t1 of the fuel gas is delayed, the generated water cannot be swept out, and the entire anode flow path PAa is filled with the generated water, which may adversely affect the power generation. Therefore, the reference rate Pat0 needs to be set to a value such that the anode flow path PAa is not filled with the generated water. As described above, the reference rate Pat0 is a decrease rate of the anode target pressure Pat which is set to determine injection start time point of the fuel gas t1 of the injector 22 when the required power decreases.

Here, a decrease rate (a decrease amount per unit time) of the anode pressure Pa due to consumption of hydrogen contained in the fuel gas by power generation is defined as a, a degree (pulsation) of rise in the anode pressure Pa by one injection of the injector 22 is defined as Pax, and a target time from start of injection by the injector 22 to start of next injection is defined as Ta. At this time, the reference rate Pat0 is calculated by the following formula (I).

Pat0=α−Pax/Ta (I)

α in the above formula (I) is a value using the power as a parameter, and can be calculated using an instantaneous output current detected by the current detection part 56. Pax in the above formula (I) can be calculated by multiplying the degree of rise in the anode pressure Pa during fuel gas injection, which is obtained in advance by an experiment, by a valve opening time of the injector 22 corresponding to the load (output current) acting on the fuel cell system 100. Ta in the above formula (I) is a sum of a time (hydrogen consumption time) Ta1 required until hydrogen held in a power generation portion (gas diffusion layer 106b) is used up and a time (full water time) Ta2 required until the generated water is accumulated in the anode flow path PAa. That is, although the generated water starts to be accumulated in the anode flow path PAa after the hydrogen of the power generation portion is consumed, if the injection is performed within a target time Ta, the generated water can be swept out before the anode flow path PAa is filled with the generated water, and the anode flow path PAa can be prevented from being filled with the generated water.

The hydrogen consumption time Ta1 can be calculated by dividing the amount of hydrogen held in the power generation portion by the amount of hydrogen consumed by power generation per unit time. Here, the amount of hydrogen held in the power generation portion can be calculated using the volume of the power generation portion stored in advance in the storage unit 64, the cooling medium temperature Te detected by the temperature sensors 54 and 55, and the anode pressure Pa detected by the pressure sensor 51. More specifically, it can be calculated by multiplying the volume of the power generation portion, the parameter corresponding to the cooling medium temperature Te, and the parameter corresponding to the anode pressure Pa. The amount of hydrogen consumed by the power generation per unit time can be calculated using the instantaneous output current detected by current detection part 56. More specifically, it can be calculated by multiplying the output current by a predetermined coefficient.

The full water time Ta2 can be calculated by dividing the volume of the anode flow path PAa stored in advance in the storage unit 64 by the amount of water permeate per unit time that is permeated (back diffusion) from the cathode flow path PAc to the anode flow path PAa. The amount of water permeate per unit time can be calculated using the instantaneous output current detected by current detection part 56.

By calculating the reference rate Pat0 using the above formula (I) and setting the anode target pressure Pat along the reference rate Pat0, it is possible to suppress an adverse effect on the power generation due to the accumulation of the generated water in the anode flow path PAa. However, in this case, since the decrease rate (slope) of the anode target pressure Pat is small, the differential pressure ΔP between the anode target pressure Pat and the cathode target pressure Pct gradually increases after deceleration start time point t0. If the differential pressure ΔP excessively increases, there is a risk that the membrane electrode assembly 104 may be damaged since it cannot withstand the differential pressure ΔP. Therefore, the differential pressure ΔP needs to be suppressed to a predetermined value ΔP1 or less. FIG. 4A illustrates an example in which, after the differential pressure ΔP reaches the predetermined value ΔP1, a pressure protection control is started, and the differential pressure ΔP decreases.

The pressure protection control is control for protecting the membrane electrode assembly 104 by suppressing an increase in the differential pressure ΔP. Although not illustrated in FIG. 4A, injection of the injector 22 is stopped or restricted when the pressure protection control is started. Therefore, in the first reference example of FIG. 4A, there arises a problem that the fuel gas cannot be injected at a desired timing corresponding to the anode target pressure Pat, leading to a decrease in the power generation performance.

FIG. 4B is a time chart as a second reference example of the present embodiment. An operation from deceleration start time point t0 to time point t2 is the same as that in FIG. 4A. Time point t2 is a time point before time point t1 in FIG. 4A, and the anode target pressure Pat decreases along the reference rate Pat0 from time point t0 to time point t2. However, in FIG. 4B, when the differential pressure ΔP reaches a predetermined value ΔP2 at time point t2, the anode target pressure Pat is decreased by a predetermined amount, and then the anode target pressure Pat is maintained constant until time point t4. Further, the anode target pressure Pat decreases again at time point t4 along the same rate as the initial reference rate Pat0 (a rate obtained by extending the reference rate Pat0 from time point t0 to t2). The predetermined value ΔP2 is smaller than the predetermined value ΔP1 in FIG. 4A.

In FIG. 4B, since the anode target pressure Pat is decreased by the predetermined amount at time point t2, the differential pressure ΔP does not increase to the predetermined value ΔP1 (FIG. 4A), and the pressure protection control can be avoided. However, in FIG. 4B, injection start time point t3 determined by an intersection PT2 of the anode target pressure Pat and the anode pressure Pa is delayed from injection start time point t1 in FIG. 4A. Therefore, the anode flow path PAa is filled with the generated water, the humidity of the electrolyte membrane 105 excessively rises, and there arises a problem that the power generation performance decreases.

As described above, in both the first reference example and the second reference example, the power generation performance may decrease after deceleration start time point t0. In this regard, in the present embodiment, in order to suppress a decrease in the power generation performance after deceleration start time point t0, the fuel cell system 100 is configured as follows.

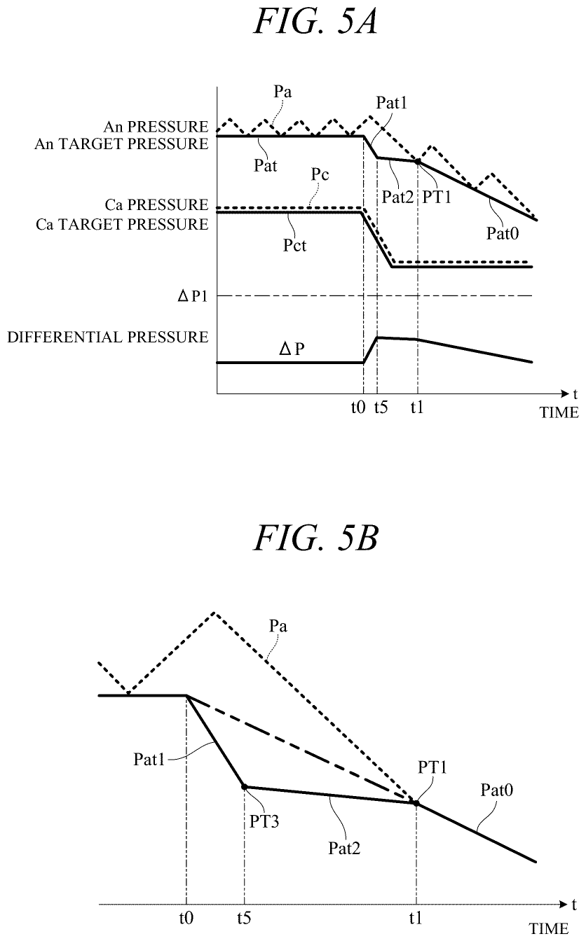

FIG. 5A is a time chart illustrating an example of an operation performed by the fuel cell system 100 according to the present embodiment when the vehicle decelerates (when an output current decreases). FIG. 5A is different from FIG. 4A in the anode target pressure Pat from deceleration start time point t0 to injection start time point t1 set by the anode control unit 62.

That is, in the present embodiment, the anode control unit 62 sets the anode target pressure Pat such that the anode target pressure Pat decreases at a first rate Pat1 from deceleration start time point t0 to time point t5, decreases at a second rate Pat2 from time point t5 to injection start time point t1, and further decreases at the same reference rate Pat0 as that in FIG. 4A after time point t1. Such setting of the anode target pressure Pat is referred to as deceleration processing.

The deceleration processing is executed when the degree of decrease in the output current corresponding to the load acting on the vehicle, which is detected by the current detection part 56, is a predetermined degree or more, specifically, when the output current decreases from a state of a first predetermined value or more to a second predetermined value or less, the second predetermined value being lower than the first predetermined value. For example, when the load acting on the vehicle decreases from a high load to a low load or from a high load to a medium load, the deceleration processing is performed. When the decrease rate of the output current (decrease rate of the load) is a predetermined value or more, the anode control unit 62 may perform the deceleration processing on the assumption that the degree of decrease in the output current is a predetermined degree or more.

The setting of the first rate Pat1 and the second rate Pat2 by the deceleration processing will be described in more detail. FIG. 5B is an enlarged view of a time chart illustrating changes in the anode pressure Pa and the anode target pressure Pat from time point t0 to time point t1 in FIG. 5A. As illustrated in FIG. 5B, the anode control unit 62 sets the first rate Pat1 to a value larger than the reference rate Pat0, and sets the second rate Pat2 to a value smaller than the reference rate Pat0. In other words, the slope of the first rate Pat1 is set to a value larger (steeper) than the slope of the reference rate Pat0, and the slope of the second rate Pat2 is set to a value smaller (gentler) than the slope of the reference rate Pat0.

A setting procedure of the first rate Pat1 and the second rate Pat2 by the deceleration processing is as follows. First, at time point t0, the anode control unit 62 sets the reference rate Pat0 by the same method as that of the first reference example (FIG. 4A), and calculates injection start time point t1 and the anode target pressure Pat (intersection PT1) at injection start time point t1. Further, the anode control unit 62 reads the cathode target pressure Pct set by the cathode control unit 61, and sets the first rate Pat1 to the same value as the decrease rate (FIG. 5A) of the cathode target pressure Pct. The decrease rate (slope in FIG. 5A) of the cathode target pressure Pct increases as the output current detected by the current detection part 56 increases. Therefore, the first rate Pat1 (slope) is set to a larger value as the output current increases.

Next, the anode control unit 62 refers to the detection value of the current detection part 56 and determines whether or not the output current has decreased to a predetermined value or less. The predetermined value is a value smaller than the second predetermined value, which is the start condition of the deceleration processing, and is a value larger than the output current corresponding to the anode target pressure Pat (intersection PT1) at injection start time point t1. When it is determined that the output current is larger than the predetermined value, the anode control unit 62 sets the anode target pressure Pat along the first rate Pat1.

When it is determined that the output current is equal to or less than the predetermined value at time point t5, the anode control unit 62 switches the decrease rate of the anode target pressure Pat from the first rate Pat1 to the second rate Pat2. In this case, the anode control unit 62 sets the second rate Pat2 by connecting, by a straight line, the anode target pressure Pat (point PT3) at time point t5 when it is determined that the output current is equal to or less than the predetermined value and the anode target pressure Pat (point PT1) at injection start time point t1. The anode control unit 62 sets the anode target pressure Pat along the second rate Pat2 from time point t5 to time point t1. The second rate Pat2 is set to a smaller value as the output current decreases. The anode control unit 62 sets the anode target pressure Pat along the reference rate Pat0 after time point t1. The reference rate Pat0 is equal to a slope of a straight line connecting the anode target pressure Pat at the time point t0 of the deceleration processing start and the anode target pressure at the injection start time point t1 (at the time point when target time Ta has elapsed).

As described above, in the present embodiment, immediately after the start of deceleration of the vehicle, the anode target pressure Pat is decreased along the first rate Pat1 having a larger decrease rate than the reference rate Pat0. Accordingly, as illustrated in FIG. 5A, the differential pressure ΔP between the anode target pressure Pat and the cathode target pressure Pct can be suppressed to the predetermined value ΔP1 or less, and the execution of the pressure protection control can be avoided. In addition, when the output current decreases to or below a predetermined value, the anode target pressure Pat is decreased at the second rate Pat2 having a decrease rate smaller than that of the reference rate Pat0. Accordingly, it is possible to avoid a delay in the start of fuel gas injection and to prevent the anode flow path PAa from being filled with the generated water. As a result, the decrease in power generation performance can be suppressed.

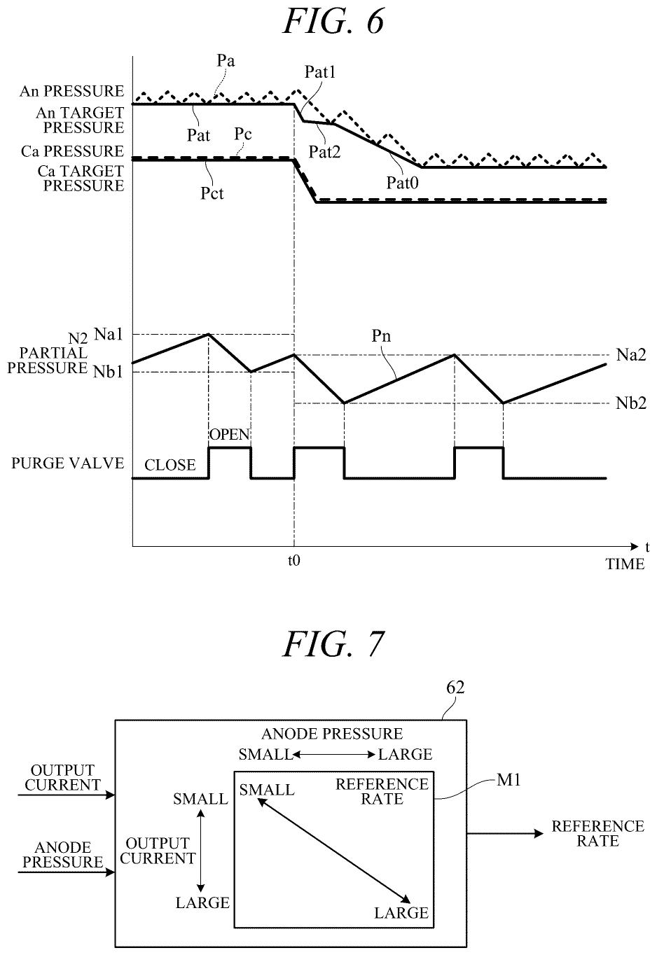

FIG. 6 is a time chart illustrating an example of a control operation by the valve control unit 63. FIG. 6 illustrates an example of a change with the lapse of time in a nitrogen partial pressure (N2 partial pressure) Pn and an opening/closing operation of the purge valve 26, in addition to a change with the lapse of time in the anode pressure Pa, the anode target pressure Pat, the cathode pressure Pc, and the cathode target pressure Pct in FIG. 5A.

As illustrated in FIG. 6, until time point t0 when the deceleration processing is started, the valve control unit 63 sets an opening threshold Na1 for opening the purge valve 26 and a closing threshold Nb1 for closing the purge valve 26. In this state, when the nitrogen partial pressure Pn rises to the opening threshold Na1 or more, the valve control unit 63 outputs a control signal to the purge valve 26 to open the purge valve 26. Accordingly, the fuel gas is discharged to the outside, and the nitrogen partial pressure Pn decreases. At this time, although not illustrated, the anode pressure Pa also decreases at the same time.

When the nitrogen partial pressure Pn decreases to the closing threshold Pb1 or less, the valve control unit 63 outputs a control signal to the purge valve 26 to close the purge valve 26. Accordingly, the discharge of the fuel gas to the outside is stopped. As described above, the purge valve 26 is opened and closed according to the nitrogen partial pressure Pn, so that the nitrogen partial pressure Pn can be maintained within a predetermined range of the closing threshold Nb1 or more and the opening threshold Na1 or less.

When the deceleration processing is started in the anode control unit 62, each of the opening threshold Na1 and the closing threshold Nb1 is changed. That is, at time point t0, the valve control unit 63 sets an opening threshold Na2 lower than Na1 and sets a closing threshold Nb2 lower than Nb1, according to the output current detected by the current detection part 56. In this case, the valve control unit 63 reads the atmospheric pressure detected by the pressure sensor 53, and sets the thresholds Na2 and Nb2 to smaller values as the atmospheric pressure is lower.

By setting the thresholds Na2 and Nb2 to be low at the start of the deceleration processing in this manner, the nitrogen partial pressure Pn reaches the opening threshold Na2 at start time point t0 of the deceleration processing. Therefore, the valve control unit 63 opens the purge valve 26 at the same time as the start of the deceleration processing. As a result, the fuel gas is discharged to the outside, and the anode pressure Pa can be rapidly decreased. Accordingly, a timing at which the anode pressure Pa becomes equal to or lower than the anode target pressure Pat is advanced, and the injection start time point t1 can be advanced. As a result, the generated water in the anode flow path PAa can be swept out at an early stage, and the power generation performance can be improved. After the purge valve 26 is opened, when the nitrogen partial pressure Pn becomes equal to or less than the closing threshold Nb2, the valve control unit 63 closes the purge valve 26.

In the above, the example has been described in which the anode control unit 62 obtains the reference rate Pat0 by calculation (the above formula (I)), but the reference rate Pat0 can also be obtained with reference to a map M1 stored in advance in the storage unit 64. FIG. 7 is a diagram illustrating an example of the map M1. In the map M1, a relationship of the reference rate Pat0 corresponding to the output current (load) detected by the current detection part 56 and the anode pressure Pa detected by the pressure sensor 51 is determined. That is, the relationship is set such that the reference rate Pat0 (slope) is larger as the output current is larger and the anode pressure Pa is larger, and the reference rate Pat0 is smaller as the output current is smaller and the anode pressure Pa is smaller. The map M1 can be obtained by performing an experiment or analysis in advance.

By referring to such a map M1, the anode control unit 62 can easily obtain the reference rate Pat0 illustrated in FIG. 5A. The anode control unit 62 may obtain not only the reference rate Pat0 but also one or both of the first rate Pat1 and the second rate Pat2 with reference to the map M1.

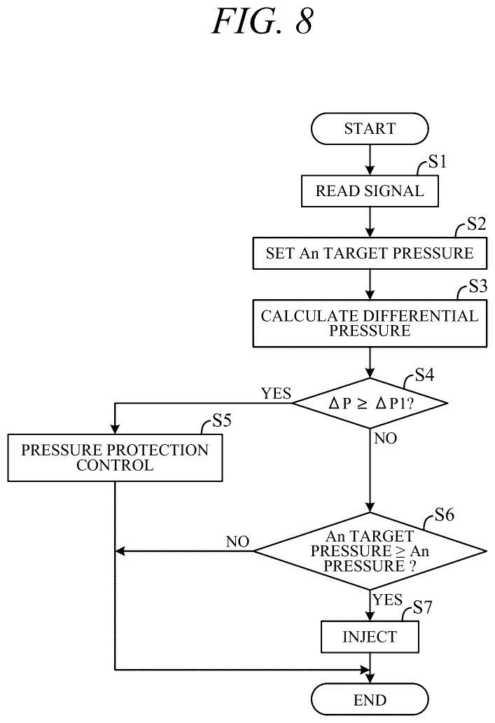

FIG. 8 is a flowchart illustrating an example of processing executed by the anode control unit 62. The processing illustrated in this flowchart is started when, for example, the output current decreases from a state of the first predetermined value or more to the second predetermined value or less and the deceleration processing is performed, and is repeated at a predetermined cycle. As illustrated in FIG. 8, first, in S1 (S: processing step), the anode control unit 62 reads signals from the sensors 51 to 55 and the current detection part 56. Further, the cathode target pressure Pct set by the cathode control unit 61 is read.

Next, in S2, the anode control unit 62 sets a decrease rate of the anode target pressure Pat based on the signal read in S1. That is, the first rate Pat1 immediately after the start of the deceleration processing is set to the same value as the cathode target pressure Pct. Further, when the output current becomes equal to or less than a predetermined value, the anode target pressure Pat at that time and the anode target pressure Pat corresponding to injection start time point t1 on a reference rate Pat0 are connected by a straight line to set a second rate Pat2. Further, after injection start time point t1, the reference rate Pat0 is set as the decrease rate. The anode control unit 62 sets the anode target pressure Pat based on these decrease rates (first rate Pat1, second rate Pat2, reference rate Pat0).

Next, in S3, the anode control unit 62 calculates a differential pressure ΔP (=Pat−Pct) between the anode target pressure Pat set in S2 and the cathode target pressure Pct read in S1. Next, in S4, the anode control unit 62 determines whether or not the differential pressure ΔP is equal to or greater than the predetermined value ΔP1. When an affirmative determination is made in S4, the processing proceeds to S5, and when a negative determination is made, the processing proceeds to S6.

In S5, the pressure protection control is executed, and the processing ends. Accordingly, the injection from the injector 22 is stopped or restricted. On the other hand, in S6, it is determined whether or not the anode target pressure Pat set in S2 is equal to or greater than the anode pressure Pa detected by the pressure sensor 51. When an affirmative determination is made in S6, the processing proceeds to S7, and when a negative determination is made, the processing ends. In S7, a control signal is output to the injector 22 to inject fuel gas.

The flowchart of FIG. 8 includes pressure protection control (S5). However, in the present embodiment, the differential pressure ΔP during the deceleration of the vehicle is suppressed to be less than the predetermined value ΔP1 by performing the predetermined deceleration processing (FIG. 5A). Therefore, the pressure protection control is not executed, and the injector 22 can inject the fuel gas at a desired timing (S7). According to the present embodiment, the following operations and effects are achievable.
(1) A fuel cell system 100 includes: a current detection part 56 that detects an output current of a fuel cell stack 1 (fuel cell) that generates power by being supplied with fuel gas (anode gas) and oxidant gas (cathode gas); an injector 22 that supplies the anode gas to the fuel cell stack 1 through a fuel gas supply flow path PA21; an air pump 31 that supplies the cathode gas to the fuel cell stack 1 through an oxidant gas supply flow path PA31; a circulation flow path PA24 that circulates the anode gas discharged from fuel cell stack 1 to the fuel gas supply flow path PA21; and an anode control unit 62 and a cathode control unit 61 that set an anode target pressure Pat and a cathode target pressure Pct, which are target pressures of the anode gas and the cathode gas, according to the output current detected by current detection part 56, and control the injector 22 and the air pump 31 according to the anode target pressure Pat and the cathode target pressure Pct (FIGS. 1 and 3). The anode control unit 62 sets the anode target pressure Pat such that, when a predetermined decrease in the output current (generated current) is detected by the current detection part 56, that is, when the output current decreases from a value equal to or greater than the first predetermined value to a value equal to or less than the second predetermined value, the anode target pressure Pat is decreased at the first rate Pat1 and then decreased at the second rate Pat2 having a decrease rate smaller than the first rate Pat1 (FIG. 5A).

According to this configuration, the decrease rate of the anode target pressure Pat is large immediately after the start of deceleration, and then the decrease rate becomes small. Accordingly, the differential pressure ΔP between the anode target pressure Pat and the cathode target pressure Pct can be suppressed to the first predetermined value ΔP1 or less, and the pressure protection control can be avoided. In addition, the delay of injection start time point t1 can be suppressed, whereby the anode flow path PAa can be avoided from being filled with the generated water. As a result, it is possible to suppress the decrease in power generation performance during deceleration.
(2) The anode control unit 62 sets the first rate Pat1 (slope) to a larger value as a decrease amount of the output current detected by the current detection part 56 is larger. Accordingly, the first rate Pat1 is set in accordance with the degree of deceleration, and it is possible to suppress an increase in the differential pressure ΔP between the anode target pressure Pat and the cathode target pressure Pct immediately after the start of deceleration.
(3) The anode control unit 62 sets the decrease rate of the cathode target pressure Pct such that the cathode target pressure Pct is decreased when the output current decreases from a value equal to or greater than the first predetermined value to a value equal to or less than the second predetermined value, and sets the first rate Pat1 to a value equal to the decrease rate of the cathode target pressure Pct (FIG. 5A). Accordingly, the first rate Pat1 can be easily set, and the increase in the differential pressure ΔP immediately after the start of deceleration can be favorably suppressed.
(4) The anode control unit 62 sets the second rate Pat2 to a smaller value as the output current is smaller. When the degree of deceleration of the vehicle is large, the output current greatly decreases, but by setting the second rate Pat2 to a smaller value as the output current is smaller, a divergence between the anode pressure Pa and the anode target pressure Pat can be suppressed, and a fuel gas injection timing of the injector 22 can be suppressed from being delayed. That is, when the output current is small, a hydrogen consumption amount decreases, and thus the degree of decrease in the anode pressure Pa decreases. In this case, if the second rate Pat2 is set to a small value, the anode pressure Pa is likely to become equal to or less than the anode target pressure Pat, and the fuel gas can be rapidly injected.
(5) The fuel cell stack 1 includes the anode flow path PAa through which the anode gas flows, and a power generation portion (gas diffusion layer 106b) that faces the anode flow path PAa capable of retaining the anode gas (FIG. 2). The anode control unit 62 calculates a target time Ta that is a sum of a hydrogen consumption time Ta1 required for consumption of the anode gas, which is determined according to the output current and a volume of the power generation portion, and a full water time Ta2 required for the anode flow path PAa to be filled with the generated water, which is determined according to the output current and a volume of the anode flow path PAa, and sets the anode target pressure Pat such that the decrease of the anode target pressure Pat at the first rate Pat1 and the decrease of the anode target pressure Pat at the second rate Pat2 are completed within the target time Ta. Accordingly, the fuel gas can be injected from the injector 22 before the anode flow path PAa is filled with the generated water.
(6) The anode control unit 62 calculates an amount of hydrogen consumed per unit time determined by the output current, and calculates an amount of water permeate per unit time that permeates from the cathode flow path PAc through which the cathode gas flows to the anode flow path PAa, based on the output current. Further, the anode control unit 62 calculates the hydrogen consumption time Ta1 by dividing the amount of hydrogen held by the power generation portion, which is determined according to the volume of the power generation portion and a pressure of the anode gas (anode pressure Pa), by the amount of hydrogen consumed per unit time, and calculates the full water time Ta2 by dividing the volume of the anode flow path PAa by the amount of water permeate per unit time. Accordingly, the hydrogen consumption time Ta1 and the full water time Ta2 can be accurately calculated, and the fuel gas can be reliably injected from the injector 22 before the anode flow path PAa is filled with the generated water.
(7) The anode control unit 62 sets the anode target pressure Pat such that, after the target time Ta elapses, the anode target pressure Pat is decreased at a reference rate Pat0 which has a decrease rate smaller than the first rate Pat1 and greater than the second rate Pat2 (FIG. 5A). In this case, since the cathode target pressure Pct has already decreased, the differential pressure ΔP between the anode target pressure Pat and the cathode target pressure Pct is small. Therefore, even if the anode target pressure Pat is decreased at the reference rate Pat0, the fuel gas can be injected from the injector 22 at a favorable timing without executing the pressure protection control.
(8) The fuel cell system 100 further includes a purge valve 26 that is provided in a purge flow path PA25 (discharge flow path) that discharges the anode gas discharged from the fuel cell stack 1 to the outside, and a valve control unit 63 that controls the purge valve 26 to discharge the anode gas to the outside when the output current decreases from a value equal to or greater than the first predetermined value to a value equal to or less than the second predetermined value (FIG. 3). Accordingly, the anode pressure Pa can be reduced to the anode target pressure Pat or less at an early stage during the deceleration of the vehicle. As a result, an increase in the differential pressure between the anode pressure Pa and the cathode pressure Pc can be suppressed, and a delay in fuel gas injection can be further suppressed.
(9) The valve control unit 63 calculates a nitrogen partial pressure Pn of the anode gas, and sets thresholds Na1, Na2, Nb1, and Nb2 of the nitrogen partial pressure Pn according to the output current (FIG. 6). That is, as the output current is smaller, the threshold is set to a smaller value (FIG. 6). Further, the valve control unit 63 opens the purge valve 26 when the nitrogen partial pressure Pn becomes equal to or greater than the thresholds Na1 and Na2. Accordingly, the anode pressure Pa can be reduced in accordance with the start of the deceleration processing.
(10) The fuel cell system 100 further includes a pressure sensor 53 (pressure detection part) that detects an atmospheric pressure (FIG. 1). The valve control unit 63 sets the thresholds Na2 and Nb2 to smaller values as the atmospheric pressure detected by the pressure sensor 53 is smaller. Accordingly, the nitrogen in the anode flow path PAa can be accurately discharged in consideration of the atmospheric pressure.

The above embodiment can be modified to various forms. Hereinafter, several modified examples will be described. In the above embodiment, the generated current is detected by the current sensor, but it may also be detected by other sensors or calculations, and the configuration of a current detection part 56 is not limited to that described above. In the above embodiment, the injector 22 controlled by the controller 60 is used as an anode gas supply part to supply the anode gas to the fuel cell via the fuel gas supply flow path PA21 (an anode supply flow path), but the configuration of the anode gas supply part is not limited to that described above. In the above embodiment, the air pump 31 controlled by the controller 60 is used as a cathode gas supply part to supply the cathode gas to the fuel cell via the oxidant gas supply flow path PA31 (a cathode supply flow path), but the configuration of the cathode gas supply flow path is not limited to that described above. In the above embodiment, the fuel gas discharged from the fuel cell stack 1 is circulated to the fuel gas supply flow path PA21 via the circulation flow path PA24 and the ejector 23, but the configuration of a gas circulation part is not limited to that described above. The anode gas may also be circulated via a circulation pump. However, this embodiment does not have a circulation pump, enabling the fuel cell system 100 to be configured inexpensively and is more preferable in this respect.

In the above embodiment, the controller 60 serving as a gas control unit, more specifically, the cathode control unit 61 and the anode control unit 62 set the cathode target pressure Pct and the anode target pressure Pat, respectively, and control the injector 22 and the air pump 31 according to the cathode target pressure Pct and the anode target pressure Pat. In this regard, as long as, when a predetermined decrease in the generated current is detected, the anode target pressure Pat is set such that the anode target pressure Pat is decreased at a first rate, and subsequently decreased at a second rate smaller than the first rate, the gas control unit may be any configuration. The first rate does not need to be the same as the decrease rate of the cathode target pressure Pct, and therefore, the first rate is not limited to the first rate Pat1 described above. The second rate is also not limited to the second rate Pat2 described above.

In the above embodiment, the deceleration processing starts when the output current decreases from a value greater than or equal to the first predetermined value to a value smaller than or equal to the second predetermined value, but the predetermined decrease in the generated current as the start condition for deceleration processing is not limited to this. For example, a decrease rate (gradient) of the generated current greater than or equal to a predetermined value can be used as the start condition for the deceleration processing. In the above embodiment, the hydrogen consumption time Ta1 (a first time) required for the consumption of anode gas which is determined according to the output current and the volume of the power generation portion, and the full water time Ta2 (a second time) required for the anode flow path PAa to be filled with the generated water, which is determined according to the output current and the volume of the anode flow path Paa are summed as the target time Ta (a predetermined time), and within the target time Ta, the decrease at the first rate Pat1 and the decrease at the second rate Pat2 for the anode target pressure Pat are completed, but the method of calculating the first time and second time is not limited to that described above.

In the above embodiment, after the target time Ta elapses, the anode target pressure Pat is decreased according to the reference rate Pat0 (a third rate), but the third rate is not limited to that mentioned above. In the above embodiment, when the deceleration processing is started, the thresholds Na1 and Na2 of nitrogen partial pressure Pn are lowered to open the purge valve 26 provided in the purge flow path PA25, but the configuration of a valve device provided in a discharge flow path is not limited to that described above. When the deceleration processing is started, the purge valve 26 may be opened independently of the setting of the nitrogen partial pressure Pn threshold, and the configuration of a valve control unit is not limited to that described above.

The above describes an example of applying the fuel cell system 100 to a fuel cell vehicle, but the fuel cell system of the present invention can also be applied to other than fuel cell vehicles.

The above embodiment can be combined as desired with one or more of the above modifications. The modifications can also be combined with one another.

According to the present invention, favorable power generation performance can be achieved while suppressing an increase in differential pressure between fuel gas and oxidant gas.

Above, while the present invention has been described with reference to the preferred embodiments thereof, it will be understood, by those skilled in the art, that various changes and modifications may be made thereto without departing from the scope of the appended claims.

What is claimed is:

1. A fuel cell system comprising:
a current detection part configured to detect a generated current of a fuel cell generating power through a supply of an anode gas and a cathode gas;
an anode gas supply part configured to supply the anode gas to the fuel cell through an anode supply flow path;
a cathode gas supply part configured to supply the cathode gas to the fuel cell through a cathode supply flow path;
a gas circulation part circulating the anode gas discharged from the fuel cell to the anode supply flow path; and
an electronic control unit including a microprocessor and a memory connected to the microprocessor, wherein
the microprocessor is configured to perform
setting an anode target pressure as a target pressure of the anode gas and a cathode target pressure as a target pressure of the cathode gas, in accordance with the generated current detected by the current detection part, and
controlling the anode gas supply part and the cathode gas supply part in accordance with the anode target pressure and the cathode target pressure,
the setting including setting the anode target pressure such that, when a predetermined decrease in the generated current is detected by the current detection part, the anode target pressure is decreased at a first rate, and subsequently decreased at a second rate having a decrease rate smaller than the first rate.

2. The fuel cell system according to claim 1, wherein
the microprocessor is configured to perform
the setting including setting the first rate to a larger value as the generated current detected by the current detection part increases.

3. The fuel cell system according to claim 1, wherein
the microprocessor is configured to perform
the setting including setting a decrease rate of the cathode target pressure so as to lower the cathode target pressure decreases when the predetermined decrease in the generated current is detected by the current detection part, and setting the first rate to a value equal to the decrease rate of the cathode target pressure.

4. The fuel cell system according to claim 3, wherein
the microprocessor is configured to perform
the setting including setting the second rate to a smaller value as the generated current detected by the current detection part decreases.

5. The fuel cell system according to claim 1, wherein
the fuel cell includes an anode flow path through which the anode gas flows, and a power generation portion facing the anode flow path capable of retaining the anode gas, and
the microprocessor is configured to perform
the setting including
calculating a predetermined time as a sum of a first time required for a consumption of the anode gas and a second time required for the anode flow path to be filled with a generated water, the first time being determined in accordance with the generated current detected by the current detection part and a volume of the power generation portion, the second time being determined in accordance with the generated current detected by the current detection part and a volume of the anode flow path, and
setting the anode target pressure such that a decrease of the anode target pressure at the first rate and a decrease of the anode target pressure at the second rate are completed within the predetermined time.

6. The fuel cell system according to claim 5, wherein
the microprocessor is configured to perform
the setting including
calculating an amount of hydrogen consumed per unit time determined by the generated current,
calculating an amount of water permeate per the unit time permeating from a cathode flow path through which the cathode gas flows to the anode flow path, based on the generated current detected by the current detection part,
calculating the first time by dividing an amount of hydrogen retained in the power generation portion by the amount of hydrogen consumed per the unit time, the amount of hydrogen retained in the power generation portion being determined the volume of the power generation portion and a pressure of the anode gas, and
calculating the second time by dividing the volume of the anode flow path by the amount of water permeate per the unit time.

7. The fuel cell system according to claim 5, wherein
the microprocessor is configured to perform
the setting including setting the anode target pressure such that, after the predetermined time has elapsed, the anode target pressure is decreased at a third rate having a decrease rate smaller than the first rate and a decrease rate larger than the second rate.

8. The fuel cell system according to claim 7, wherein
the third rate is equal to a slope of a straight line connecting the anode target pressure when the predetermined decrease in the generated current is detected by the current detection part and the anode target pressure when the predetermined time has elapsed.

9. The fuel cell system according to claim 1, wherein
the gas circulation part includes an ejector disposed in the anode supply flow path.

10. The fuel cell system according to claim 1, further comprising
a valve device provided in a discharge flow path discharging the anode gas discharged from the fuel cell to an outside, wherein
the microprocessor is configured to further perform
controlling the valve device to discharge the anode gas to the outside when the predetermined decrease in the generated current is detected by the current detection part.

11. The fuel cell system according to claim 10, wherein
the microprocessor is configured to perform
the controlling including calculating a nitrogen partial pressure of the anode gas, setting a threshold value for the nitrogen partial pressure in accordance with the generated current detected by the current detection part, and opening the valve device when the nitrogen partial pressure becomes equal to or greater than the threshold value.

12. The fuel cell system according to claim 11, further comprising
a pressure detection part detecting an atmospheric pressure, wherein
the microprocessor is configured to perform
the controlling including setting the threshold value to a smaller value as the atmospheric pressure detected by the pressure detection part decreases.
